(19) United States
(12) Patent Application Publication
(10) Pub. No.: US 2026/0041048 A1
(43) Pub. Date: Feb. 12, 2026

(54) INTELLIGENT SUBSURFACE INJECTION IRRIGATION SYSTEM

(71) Applicant: Ali KAVAKPOUR, Antalya (TR)

(72) Inventors: Mobina KAVAKPOUR, Tehran (IR); Sedighe KAVAKPOUR, Tehran (IR)

(21) Appl. No.: 19/100,563

(22) PCT Filed: Aug. 7, 2022
(86) PCT No.: PCT/IB2022/057349

§ 371 Date: Mar. 9, 2025

(51) Int. Cl. A01G 25/06; A01G 25/16

(52) U.S. Cl. CPC A01G 25/06; A01G 25/16

(57) ABSTRACT

The invention of intelligent subsurface injection irrigation system is a type of integrated injection irrigation system that intelligently irrigates plants and uses available water resources with maximum economy and highest possible efficiency. The present invention includes an inverted conical tank and a water supply system equipped with a floater, a digital moisture meter sensor equipped with a transmitter as well as a humidity sensor information transmission system and also a sensor and thermostatic valve system for connecting and disconnecting the water, a water transfer pump from the main water storage pool to the water transfer network, a control room and a liquid fertilizer injection system in the transfer network as well as a bypass equipped with a valve in the water transfer network and a water storage pool and aquaculture. Also this invention relates to subsurface irrigation methods and systems for detection of humidity and temperature for correct watering.

### TECHNICAL FIELD OF THE INVENTION

The present invention relates to irrigation system in agriculture, including under pressure irrigation systems, water storage systems and intelligent water supply to trees and plants, and also relates to subsurface irrigation methods and also relates to systems for detection of humidity and temperature for correct watering.

### PRIOR ARTS

Given to the non-uniform distribution of water resources on the surface of the earth, as well as the existence of dry belts in the northern and southern hemispheres and the existence of deserts and wilderness and low water points, the process of supplying water to plants and gardens has always been one of the leading challenges. In the meantime, humans have started the agricultural process near rivers and fresh water sources, and by increasing the population and increasing the demand for agricultural and horticultural products, cultivated lands were not able to meet the needs of the growing human society. Therefore, lands with a little distance from water resources have also been used for the agricultural process. In areas where the rainfall level is relatively higher, dry farming type of agriculture became common. With the construction of water supply routes, the transfer of water from water sources to gardens and agricultural areas generalized. In traditional irrigation, in general, the digging of canals and runnels, which in most cases do not have a suitable cover in the bottom, also caused a large amount of water sent to the lands and agricultural gardens to evaporate or leak into the ground. Further, to optimize the irrigation systems, using covered pipes and canals of water transferring, reduced the volume of lost water.

With the promotion of human knowledge, the rain irrigation system as well as under pressure drip irrigation structures reduced the amount of water consumption in gardens and lands. Despite the reduction of water loss in this type of irrigation mechanisms, due to the penetration of water into the ground and the removal of moisture from the accessibility of the roots, on average less than 30% of the water used is provided to the plant. The surface evaporation around the plant and the dispersion of soil moisture and the removal of said moisture from the accessibility of the roots have always made the amount of water used for irrigation several times higher than the water used by the plant. In the meantime, the irrigation process is defined and implemented in specific intervals and periodically, depending on the soil conditions, plant type and weather conditions. Now, by decreasing the subsurface water resources, wells and aqueducts, which are used as sources for extraction of water in areas far away from surface water sources, gradually their irrigation efficiency has become less and less, so that the share of water taken from these sources no longer has the ability to meet the needs of agricultural lands and gardens, and this has caused a large part of the gardens to disappear due to lack of water. Also, water resources for creating new forests and gardens are very limited. Most of the mentioned problems mostly show themselves in the dry belts of the earth. In the parts of the earth where the air humidity is very low and there is not enough and continuous rainfall, we are currently witnessing vast deserts and wilderness. In this regard, experts and scientists in the mentioned field have tried to explain newer methods with greater efficiency. Subsurface irrigation is one of the ways to optimize water consumption. In this method, water distribution nozzles are placed in the lower part of the soil and thus water is delivered to the soil at a point where the minimum amount of surface evaporation occurs. In these methods, water is generally transported near the roots with the help of pipes and tanks that are already planted in the soil and is directly available to the roots. Among these methods, subsurface drip irrigation is an example. With the promotion of irrigation techniques, the use of slow release methods made it possible to irrigate the roots slowly and with focus. In the meantime, many innovations and inventions have been done, and by researching a large number of them, the following items are among the closest to the concept of the present invention. Among the discussed techniques, can mention to method provided in the invention with registration No. CN203692101U which is granted in Chinese patent office dated 2014 Jul. 9 titled “Novel fruit tree root system drop irrigation intelligent control device” provides a novel fruit tree root system drop irrigation intelligent control device. An annular drop irrigation device surrounds a fruit tree root 20 cm underground, a humidity sensor is close to the annular drop irrigation device and is connected with a controller, a water collecting platform is arranged on the ground, a purified water storage pool is arranged under the water collecting platform and is located underground, a horizontally-arranged filter layer is arranged in the middle of the water collecting platform, an activated carbon water purification layer is arranged at the bottom of the water collecting platform, the purified water storage pool is arranged under the activated carbon water purification layer and is located underground, a solenoid valve is arranged at the bottom of the purified water storage pool, the annular drop irrigation device is connected with the solenoid valve through a water conveying pipe, and the controller is connected with the solenoid valve. The novel fruit tree root system drop irrigation intelligent control device achieves underground irrigation, the soil structure cannot be damaged, automatic detection and timely water supplementation and injection are achieved.

A patent application with publication No. WO2018099536A2 which is filed in WIPO dated 2017 Feb. 21 titled “Irrigating trees by injectors near roots” relates to a cylindrical injector for the trees irrigator laid under the surface of the soil with depth 10 cm to 100 cm near the roots of the trees to deliver the water to the roots of the trees directly by injection and filtration without passing of water on the surface of the soil, wherein said cylindrical injector prevents the vegetation, reduces the salinity and protect itself from entering of the roots in it and could be maintained without digging the soil. in this invention Water and pressure reach the injector through a flexible plastic hose. Because the injector is tightly closed, and when the soil doesn't absorb all the water in the injector, water level rises in the injector to cover all the holes around it. The pressure of the water grid will force water to seep out of the injector to the soil, and then to the roots of the tree. Therefore no hygrometer sensor is used in this invention.

Another Chinese patent with publication No.CN102763587A which is filed dated 2012 Aug. 14 titled “Plant root water injection irrigation system” relates to a plant root water injection irrigation system comprising a water supply device and water control valve connected with the water supply device, a main irrigation pipeline connected with the water control valve and paved on the soil and a group of irrigation branch pipelines connected with the main irrigation pipeline. Water injection needles are respectively arranged on the group of irrigation branch pipelines, and the water injection needles are inserted in soil of the roots of plants. Water is injected in the plants through the water injection needles inserted at the positions of the roots of the plants, and the water injection needles are connected to form an irrigation network, and a water-saving efficient irrigation technique is achieved. Soluble fertilizer can be blended in the device in an irrigation process so as to achieve irrigation and fertilizing integration. The plant root water injection irrigation system is high in automation, simple to use, convenient to manage, capable of being reused and favorable for water and fertilizer absorption of the plants through an irrigation method for injecting water and fertilizing at the roots of the plants directly.

A Chinese patent with publication No. CN105191757A which is filed dated 2015 Oct. 27 titled “Buried type water-saving fruit tree irrigation device” provides a buried type water-saving fruit tree irrigation device which comprises a water source and a water pump. A water inlet pipe is arranged between the water pump and the water source 1. A water conveying hose is arranged on one side of the water pump. An annular water conveying pipe is arranged at one end of the water conveying hose. A plurality of water conveying branch pipes are evenly arranged at the bottom of the annular water conveying pipe. A plurality of water outlets are formed in the pipe walls of the water conveying branch pipes. A humidity monitoring rod is arranged on one side of the water conveying branch pipes. A temperature monitoring rod is arranged at one end of the top of the annular water conveying pipe. An irrigation analysis module is arranged on a shell of the water pump. The temperature monitoring rod and the humidity monitoring rod are both electrically connected to the irrigation analysis module. Due to the buried type design, water can be well absorbed by root systems of fruit trees, water is less evaporated, and the water resource utilization rate is increased; due to the humidity monitoring rod, soil moisture can be monitored, irrigation is conducted when moisture is not enough

Another Chinese patent with registration No. CN105794597B which is granted dated 2019 Feb. 1 titled “It is a kind of that layering constant-pressure infiltration irrigation system and method are carried out according to root system of plant distribution” provides a kind of irrigation field and atumation saving the agricultural water comprising filter screen, supervisor, water pump, non-return valve, regulating valve, Development of Venturi Fertilizer Applicator, cascade filter, well strainer, Flowmeter, pressure sensor, fertilizer spreading tank, main pipe, solenoid valve, Infiltrating irrigation pipe, humidity sensor, humidity sensors, humidity sensors, mulch, exhaust valve, controller, frequency converter. when pressure sensor detects the pressure in supervisor lower than setting value When, it opens frequency converter, increases pressure It when detecting that pressure is higher than setting value, opens frequency converter, reduces pressure, when No. 2 humidity sensors detect that soil moisture changes, No. 1 solenoid valve is close, When No. 3 When humidity sensor detects that soil moisture is higher than setting value, No. 2 solenoid valves are close, Step 5, after No. 1 solenoid valve and No. 2 solenoid valves are turned off, infiltrating irrigation terminates, and switch off the pump, keeps control device processed is opened, and next infiltrating irrigation period is waited.

A Chinese patent with publication No. CN111165214A which is filed dated 2020 Feb. 17 titled “Plant irrigation and temperature control system” provides a planting irrigation and temperature control system, which comprises a concave groove, wherein a heat insulation layer is arranged on the inner wall of the concave groove; a partition plate is arranged in the concave groove, and a water passing channel is formed between the partition plate and the bottom wall of the concave groove; a soil sandstone layer for planting crops is paved on the clapboard. According to the invention, the water passing channel is formed between the concave groove and the partition plate and between the partition plate and the bottom wall of the concave groove, and when irrigation is not needed, the water passing channel below the partition plate provides air required by growth for the roots of crops; when irrigation is needed, a water source is conveyed into the water passage, and water can permeate upwards for irrigation; when the soil temperature needs to be regulated, heated water can be input into the water passing channel through a pipeline, the water temperature is reduced and does not act with the soil by utilizing the hydrothermal heating partition plate and the soil, and then the water flows out through the water passing channel; when rainwater exists, the rainwater can penetrate through the soil and flow into the water passing channel through the partition plate, and the rainwater flows out through the water passing channel to prevent water logging.

Another Chinese patent with publication No. CN111650859A which is filed dated 2020 May 27 titled “Garden maintenance system” discloses a garden maintenance system which comprises a central processing control device, a soil humidity sensing device, a soil nutrient sensing device, an air temperature and humidity sensing device, a drainage device, a monitoring device, a water and fertilizer integrated device, a cleaning device and a pesticide spraying device. The soil humidity sensing device is connected with a first input end of the central processing control device, the soil nutrient sensing device is connected with a second input end of the central processing control device, the air temperature and humidity sensing device is connected with a third input end of the central processing control device, and the monitoring device is connected with a fourth input end of the central processing control device.

And another Chinese patent with publication No. CN112655347A which is filed dated 2021 Jan. 20 titled “Method and system for controlling growth environment of root system of soil culture” discloses a method and a system for controlling the growth environment of a root system of a soil culture, wherein a circulating water infiltrating irrigation system is constructed by a circulating pump, a water supply pipe, a water return pipe, a circulating underground infiltrating irrigation pipe and a water supplementing and constant pressure device. The circulating underground infiltrating irrigation pipe is provided with a water outlet and is embedded in the soil of the plant planting area; after the circulating pump is started, the irrigation water is pushed to circularly flow in the circulating pump, the water supply pipe, the circularly buried infiltrating irrigation pipe and the water return pipe; and the irrigation water seeps out through the water outlet hole under the action of the pressure of the infiltrating irrigation water in the circulating underground infiltrating irrigation pipe and permeates and diffuses to the soil on the periphery of the circulating underground infiltrating irrigation pipe.

Another Chinese patent with registration No. CN201084955Y which is granted dated 2008 Jul. 16 titled “Pouring irrigation machine” provides a pouring irrigation apparatus, which belongs to an appliance used for the irrigation and fertilization of fruit tree, plant and other appliances. The pouring irrigation apparatus has an annular water distributing pipe connected with a water inlet pipe, a plurality of water diversion pipes are communicated at the lower end the annular water distributing pipe, soil drilling and water injecting devices are installed at the lower ends of the water diversion pipes. When the pouring irrigation apparatus is used, underground irrigation water is injected the soil of the plant root, therefore the moisture evaporation on the earth surface is reduced, and soil aggregate structure can be prevented from being damaged, the soil can not be hardened. There is the ability to move the drip irrigation device and it is easy to carry, and timely watering of fruit trees and other plants can be done at any moment.

In another Chinese patent with registration No. CN205030289U which is granted dated 2016 Feb. 17 titled “Automatic irrigation system of trees water conservation” discloses an automatic irrigation system of trees water conservation, automatic irrigation system of trees water conservation, it is constituted including the storage water tank, the outlet and the defeated water piping connection in underground of storage water tank, the underground raceway with bury at the regional water piping connection that oozes of root, the underground raceway passes through the solenoid valve with the infiltration pipe and is connected, has buried the soil moisture sensor underground at root of tree, soil moisture sensor and transmission bus connection, the transmission bus inserts microcontroller, microcontroller can control solenoid the switch, the infiltration pipe is circular the setting around the root.

Another Chinese patent with registration No. CN211532209U which is granted dated 2020 Sep. 22 titled “Wisdom gardens management system” provides a smart garden management system, which comprises a climate recognition detection device, a weather information recognition device and a control device, wherein the climate recognition detection device is arranged in a garden and used for recognizing climate information; the intelligent terminal controller is connected with the output ends of the climate recognition detection device and the environmental information acquisition device and generates a control command based on the climate information and the environmental information. The garden irrigation execution device is connected with the output end of the intelligent terminal controller and executes irrigation operation based on the control command; and the power supply device is used for supplying power to the climate identification detection device, the environmental information acquisition device and the garden irrigation execution device.

Also the Chinese patent with registration No. CN106613769B which is granted dated 2020 Mar. 24 titled “Sponge urban underground buried pipe irrigation system and construction method thereof” a spongy urban underground buried pipe irrigation system and its manufacturing method have been presented. This method includes the following steps: hidden piping, construction of a flow distribution box, construction of a storage box, construction of a seepage pipe, and performance testing of an irrigation system. This method has simple steps and can effectively achieve the purpose of rainwater recycling for underground irrigation in a way that there is a sponge inside the chamber placed under the soil that stores rainwater and saves water from storage and it is used for underground irrigation of plants.

And another Chinese patent with publication No. CN111587716A which is filed dated 2019 Feb. 20 titled “Automatic soil humidity control system and application thereof in underground irrigation, space farms, desert field building and the like” relates to a process technology and a device of an automatic soil humidity control system. An underground irrigation system comprising a plurality of in-soil water pressure detectors, a plurality of bi-directional flow conduits, each connected to a set of a plurality of in-soil water pressure probes, a bidirectional flow water pipe connected to the plurality of bidirectional flow ducts, a water source water pressure control groove connected to the bidirectional flow water pipe, a buffer tank, the input and output pipes of which are connected with the water source hydraulic pressure control tank, a water purifier connected to the water source hydraulic pressure control tank, a water collection tank, which is connected to the water purifier, a plurality of drain pipes having holes are buried under a deep root zone of soil in a crop area, and a drain pipe having a first end connected to the plurality of hole-containing drain pipes and a second end connected to the water collection tank.

According to the founded article in https://www.groasis.com/en/can observe that a device named Waterboxx which is brainchild of a Dutch businessman, Peter Hoff, is used for irrigation in environments with low rainfall, with temperature more than 40 degrees of centigrade and even it is suitable for using in eroded and stony soils. This device is made of polypropylene (plastic) and therefore it can be used 10 times. The tree needs a box of 9 to 12 months to grow. When the tree no longer needs the Waterboxx, the box can be carefully removed from the tree and reused.

Also another article related to subsurface irrigation is founded in https://www.gcsaa.org/uploadedfiles/Course/Golf-Course Features/Bunkers/Water-from-underground.pdf according to which a method and system provided for underground irrigation in slope fields and to prevent loosing water. Based on the method mentioned in this article temporary network was set up on top of the sand in a shelter connected to a quick-connect valve. After the implementation, small wet areas protruded from the tubular droppers and continued to extend in diameter until finally the wet areas merged together. The network is dotted with paint using 12″ to 18″ lateral spacing. In this method, a gap is created in the form of a V, and the pipe is inserted at the appropriate depth and connected to the water source.

Another method of subsurface irrigation is the OLLA system or irrigation with jug. In this method, by pouring water into the unglazed clay jugs and locating under the ground near the plant root, it causes the moisture that exudes from the jug to the soil to provide the necessary water of the plant. A part of this jug or clay container is placed outside the surface of the earth, which can provide the required water through the hole in its head. The images related to this method can be seen through the below link: https://www.pinterest.com/pin/872713234016987220/?mt=login.

In the aforementioned inventions, the method of water injection into the space near the root or water storage systems next to the root as well as the slow water release system have been used. Elements such as storage tanks as well as pipes and water transfer hoses are seen in most of the inventions. The use of independent pumps, electric valves, and electronic controllers are among the available elements, but in many cases, the lack of electricity sources in gardens and farms, as well as the need to replace and modify the elements used in the discussed mechanisms, is one of the cases that make the use of the mentioned technologies a little difficult. Also, in most cases, the high complexity of the used techniques or the damages of the required items in the long time can shorten the operation time of these mechanisms. It is better to mention that fertilization processes as well as the use of common micronutrients also cause damage to the mechanism in most cases.

### DESCRIPTION OF THE INVENTION

The present invention is a type of integrated injection irrigation system that intelligently irrigates plants and uses available water resources with maximum economy and highest possible efficiency. In this invention, a tank (FIG. 1, part 4) with a circular cross section is designed in such a way that the downstream part of the tank is cylindrical in shape and has the ability to hold a certain volume of water. The upper part of the tank is designed as an inverted incomplete cone. In the bottom of the tank, there are 4 holes (FIG. 6, part 1) with equal distances at the vertex of a square. In the lower part of the tank body, holes are extended in the form of hollow tubes (FIG. 7, part 1). In the upper part of the tank and close to the tank door, a middle door (FIG. 1, part 3) is installed in such a way that it has a bit upward convexity. The said door has 2 holes, one of which is for the water transfer connections and the other is created as a pressure correction valve inside the tank. The mentioned door separates the upper part of the tank from the lower part. The connections of the door to the tank are installed in such a way that when the middle door is inserted into the tank, the presence of a peripheral ring causes the middle door to be fixed and locked in the tank. The conical shape of the upper part makes the said tank not tends to sink and settle in the soil due to its weight inside the place of installation. By placing the middle door and due to the upward convexity of the door, if water enters the tank, the existing water will tend to move to the periphery and enter the tank through the mounted hole. The circularity of the tank and the door cause to be no difference in its performance by placing the middle door in the tank in every manner.

In the upper part of the tank, there is a circular door in a concave shape, which is completely fixed with a raised ring outside the container, which prevents the entry of dirt, waste and foreign objects into the container. The concavity of the mentioned door causes rainwater to accumulate in its center during rain and enters the container through the mounted hole, and after collapsing on the middle door, it enters the main tank. On the said door, there is a place for entering the branch of the water transfer pipe (FIG. 1, part 10). In the lower part of the tank, two series of flexible tubes (FIG. 1, parts 5 and 6) are connected to the outlets of the tank in such a way that on one side the beginning of the tube and on the other side the end of the tube are connected to the tank after going through a complete loop. The present tubes are placed horizontally around the plant in a way that forms two concentric circles (FIG. 3). The first circle (FIG. 1, part 6) has a smaller diameter and the second circle (FIG. 1, part 5) has a larger diameter. In each of the loops, there is a thermostatic system (FIG. 1, part 7) based on increasing the length of a copper wire with a polymer coating which is kept in a protective pod (FIG. 4), which makes it possible to increase the length of the wire in its pod in a way that due to its long length, very small changes in temperature can increase its length by a few millimeters. At the beginning of the mentioned pod is designed in such a way that before assembling the water transfer tubes can be entered to the tank from one side and fixed with a plastic bead from inside the tank. In this way, the outer pod is fixed to the base of the tank and the changes in the length of the wire comparing with its pod can be obvious in the other part of the pod. Existence of an adjustment screw which has the same head as the wire make it possible at the beginning of the thermostatic wire pod that by opening and closing the screw, control the placement of the other end of the wire. At the other end of the wire there is a connection system which is installed to the lower hole of the tank in such a way that if the length increase due to the heat, the wire (FIG. 4, part 6) apply pressure to a valve (FIG. 4, part 11) and by opening and closing the valve allow the water to flow from inside the tank in to the tube. Given that the alloy used in thermostatic wire can be made of other corrosion-resistant and elastic metals, if necessary these alloys can be used instead of coated copper metal. In order to make the tank water flow in each of the loops, other types of thermal sensors, electric valves equipped with electric sensors or other equipment for switching the flow on and off based on measuring the temperature can be used, and the present invention is not limited to the aforementioned thermostatic sensor.

The set of mentioned device (FIG. 3) is installed next to the plant under the ground. The tubes which inside them keep the thermostatic wires, after going down and reaching the correct level of the root, are transferred to the horizontal plate by going through a 90 degree bend (FIG. 1, part 5 and 6) and go through the desired loop on the horizontal plate, then it is connected again with a mild slope to the other connection of the bottom of the tank. First by evaluating the amount of temperature and soil moisture and using the data about the optimal humidity and temperature of the soil at the depth of the installation of the tubes, by adjusting the set-up screw (FIG. 1, part 1) can adjust and control the water flow in the tubes. In case of increasing the temperature due to losing the humidity of the soil, the length of the thermostatic wire increased and by changing the location of the valve in millimeters, the water inside the tank flows in to the tubes and given to existence of thousands holes on the tubes, the water is transferred to the soil around the root under the gravity pressure and cause to increase the level of humidity of the soil. By increasing the humidity, the temperature of the soil decrease and by decreasing the temperature of the soil, the length of thermostatic wire decreased and the water flow into the tubes is interrupted. Each of water transferring tubes can be installed in a separate plate from the other tube plate. Also it is possible to place each of tubes in a plate transverse to the other tube plate. If needed the number of outlet of the tank can be increased in pairs and accordingly the third tubes or more are designed and installed. Existence of numerous tubes guarantees the operation of the device and the non-drying of the soil in case of problem in any of the other tubes. Depending on the type of plant and the aggressive behavior of the roots, it is possible to cover around the water transfer tubes using sand piles (FIG. 2, part 1). This sand pile can have different sizes in granulation. The existence of this pile causes the water to enter the sand pile after leaving the transfer tubes and then the aforementioned moisture is transferred from the sandy part to the soil around the roots. In this way, the amount of root invasion to the openings of the tubes is minimized. Due to the extent of the wet area in this device, the tendency of the plant root to attack and immigrate to the openings of the transmission tube is minimized.

A moisture meter sensor (FIG. 5, part 3) in the area of operation of the tubes can send the detection of emptiness of the tank of the system to the central control room (FIG. 5, part 7) in case of reduction of the humidity of the soil and falling the humidity from the set upped standard. At this time, the water transferring pump (FIG. 5, part 6) to the system turns on and existence of the positive pressure in the transfer network cause the water to enter to the tank. By entering the water inside the tank and increasing the humidity, the Moisture meter message is interrupted and the control room sends the command to stop the water flow and turn off the pump. Since there may be a phase delay between the moisture sensor signal and the filling of the tank and the closing of the inlet flow floater, therefore the presence of the pressure switch or a valve equipped with mechanical pressure control installed on the bypass of the pump can correct the delay of the command to stop the flow or prevent the transfer pump from going under pressure by creating a bypass (FIG. 5, part 5). If needed the tank of system can be equipped by a level gage to detect whether it is full or empty. In any case, the information transfer from the Moisture Meter sensor or level gage is sent to the control room with the help of transmitter and with wireless protocol or lora wan. At time of using the present device in large numbers and regularly and with pre-defined arrangement, it is possible to act in such a way that the outer loop of the device can also provide minimum humidity to the side plant while providing humidification to the related plant. At this time, in case of damage in one of humidification equipments, the side devices can prevent the plant from drying out. It is possible to create an irrigation network consisting of a large number of the same devices for watering plants, and it is possible to create a water transfer system in the form of a network. In this case, each of equipments can start the pump and fill the tank and complete other half-empty tanks if the command is sent that the tank is empty. In this way, the possibility of complete emptiness of other tanks along with the target tank is minimized. In the main water storage tank of the network (FIG. 5, part 8) by using appropriate fishes and breeding such fishes at the same time with placing ducks as mud-eating birds, it is possible to maximize the amount of nitrates and nutrients in water through the feces of fishes and ducks, and thus it is possible to feed plants with water enriched with nitrates of organic origin. If fertilization is needed, it is possible to use water-soluble fertilizers at the beginning of the transmission network (FIG. 5, part 4). It is also possible to bury animal manure or chemical granules by digging regular holes around the plant. The moisture created over time causes the transfer of micronutrients from the fertilizer pits to the root access area.

### BRIEF DESCRIPTION OF THE DRAWINGS

FIG. 1 is the view of intelligent water injection device around the plant's root, including:
1. Set up screw of thermostatic wire
2. Door of the tank
3. Middle door of the tank
4. Body of the tank
5. Water transferring loop
6. Water transferring internal loop
7. Thermostatic wire sensor
8. Water entering valve to the loops
9. Water level adjustment floater
10. Connection of water supply network to the device
11. Water branching
12. The main tube

FIG. 2 is the view of surrounding the loops using sand.

FIG. 3 is the manner of placing the device around the root and networking the tree irrigation system.

FIG. 4 is the beginning and ending view of the thermal sensor equipped with water entering valve.

FIG. 5 is the view of connection of equipments network to the water transferring lines with system of sending and receiving the signal from moisture meter, control room and water storage pool.

FIG. 6 is the lower view of the tank.

FIG. 7 is the side view of the tank.

FIG. 8 is the side view of door of the tank.

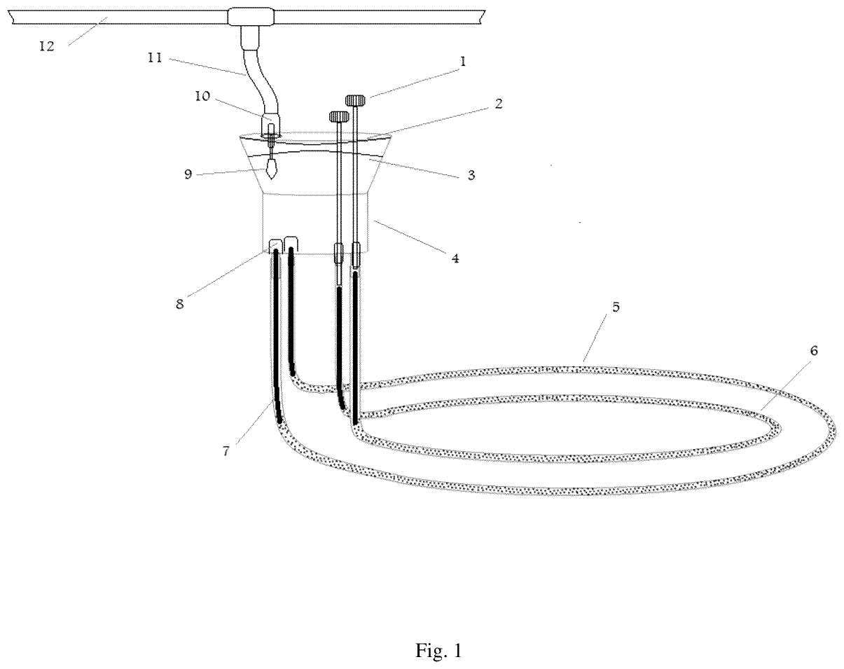

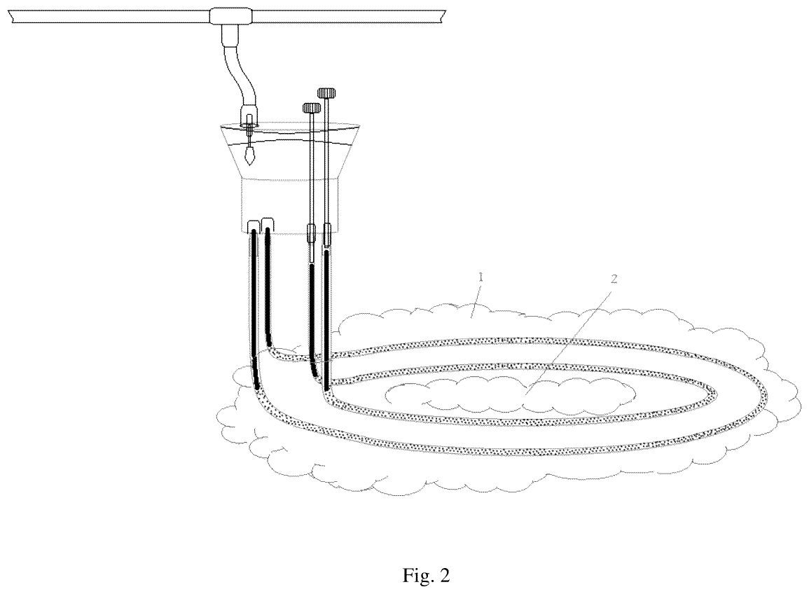

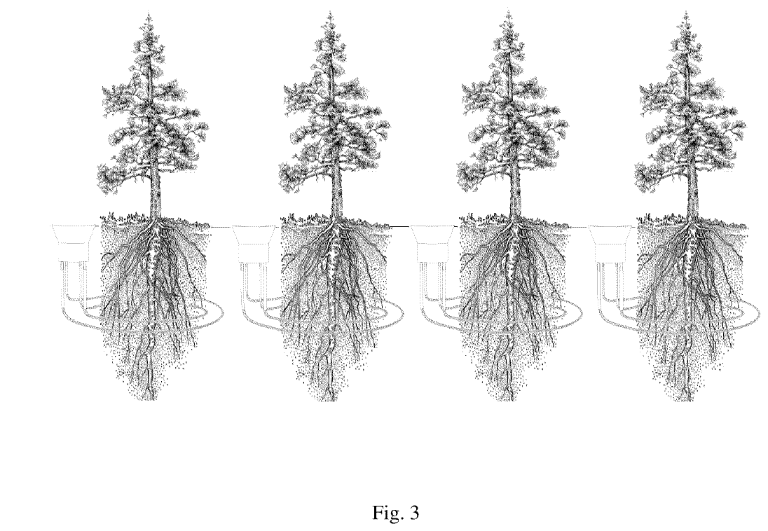

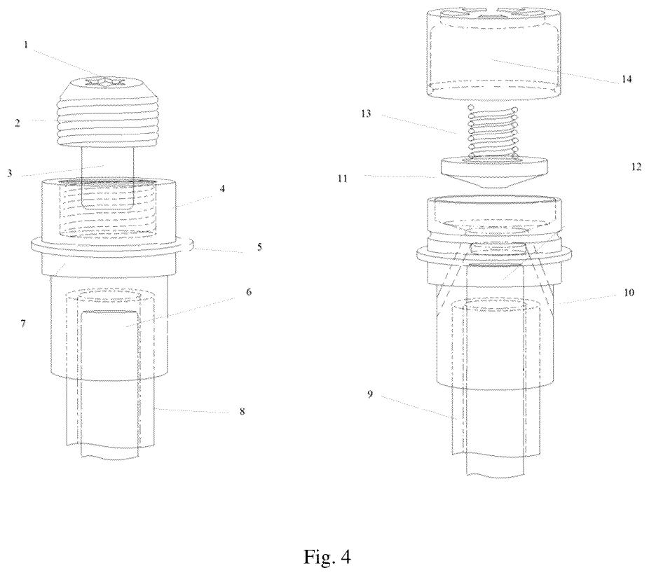

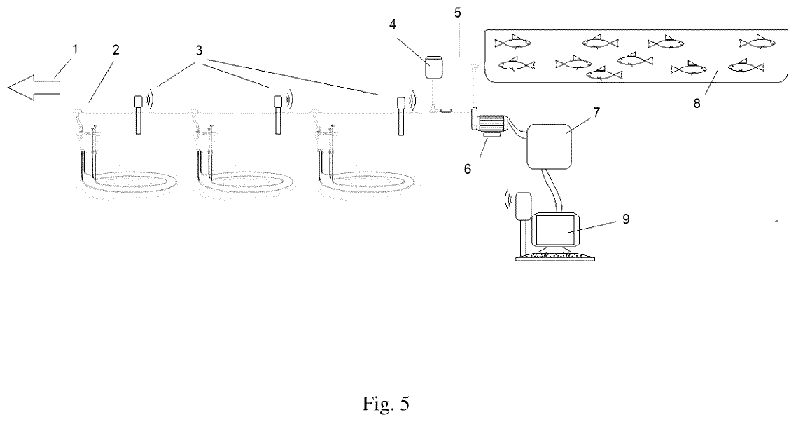

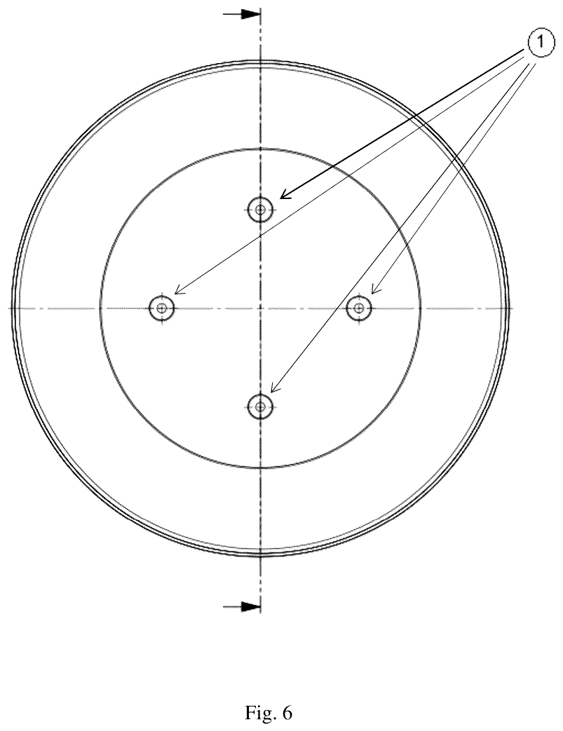

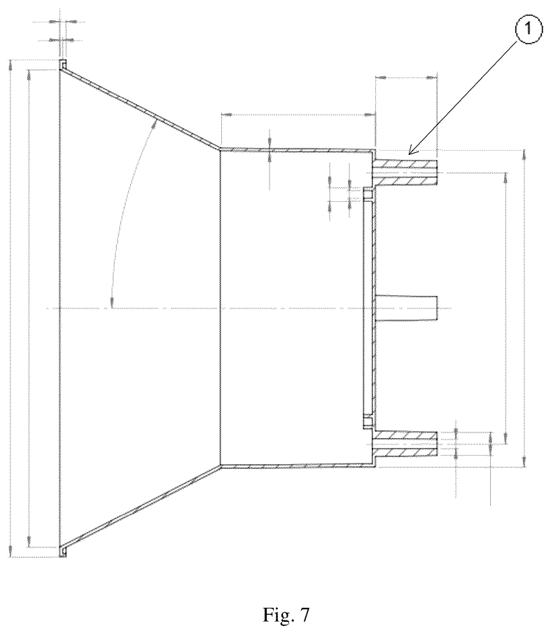

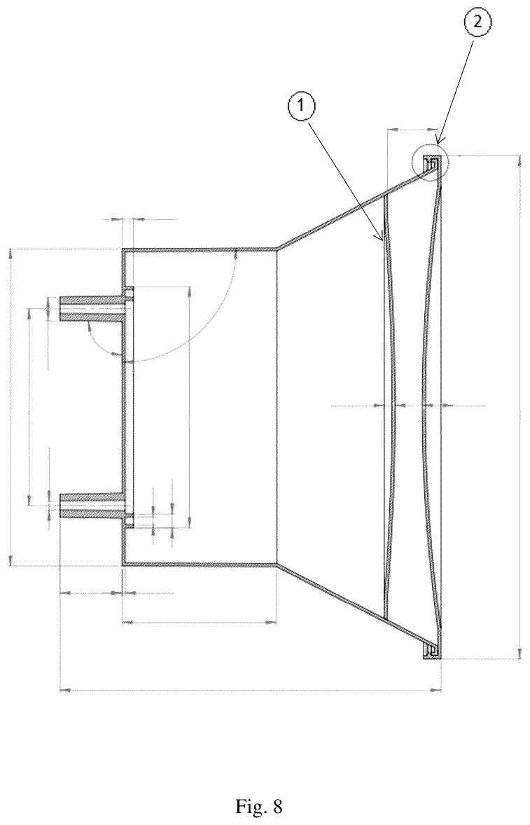

What is claimed is:

1. The invention of intelligent subsurface injection irrigation system includes at least one inverted conical tank and at least one water supply system equipped with a floater and at least one digital moisture meter sensor equipped with a transmitter and at least one humidity sensor information transmission system and at least one sensor and thermostatic valve system for connecting and disconnecting the water flow and at least one water transfer pump from the main water storage pool to the water transfer network and at least one control room and at least one liquid fertilizer injection system in the transfer network and at least one bypass equipped with a valve in the water transfer network and at least one water storage pool and aquaculture.

2. The irrigation system of claim 1 which is a type of integrated injection irrigation system for irrigating plants and with maximum saving of available water resources.

3. The irrigation system of claim 1 in which a tank with a circular cross section is designed in such a way that the downstream part of the tank is cylindrical in shape and has the ability to hold a certain volume of water.

4. The irrigation system of claim 1 in which the upper part of the tank is designed as an inverted incomplete cone.

5. The irrigation system of claim 1 which in the bottom of the tank, there are 4 holes with equal distances at the vertex of a square.

6. The irrigation system of claim 1 which in the upper part of the tank and close to the tank door, a middle door is installed in such a way that it has a bit upward convexity.

7. The irrigation system of claim 1 in which the middle door separates the upper part of the tank from the lower part.

8. The irrigation system of claim 1 which the connections of the door to the tank are installed in such a way that when the middle door is inserted into the tank, the presence of a peripheral ring causes the middle door to be fixed and locked in the tank.

9. The irrigation system of claim 1 which the conical shape of the upper part makes the said tank not tends to sink and settle in the soil due to its weight inside the place of installation.

10. The irrigation system of claim 1 which by placing the middle door and due to the upward convexity of the door, if water enters the tank, the existing water will tend to move to the periphery and enter the tank through the mounted hole.

11. The irrigation system of claim 1 which the circularity of the tank and the door cause to be no difference in its performance by placing the middle door in the tank in every manner.

12. The irrigation system of claim 1 which in the upper part of the tank, there is a circular door in a concave shape, which is completely fixed with a raised ring outside the container, which prevents the entry of dirt, waste and foreign objects into the container.

13. The irrigation system of claim 1 which the concavity of the upper door causes rainwater to accumulate in its center during rain and enters the container through the mounted hole, and after collapsing on the middle door, it enters the main tank.

14. The irrigation system of claim 1 which in the lower part of the tank, two series of flexible tubes are connected to the outlets of the tank in such a way that on one side the beginning of the tube and on the other side the end of the tube are connected to the tank after going through a complete loop.

15. The irrigation system of claim 1 in which the lower tubes are placed horizontally around the plant in a way that forms two concentric circles.

16. The irrigation system of claim 1 in which the first circle has a smaller diameter and the second circle has a larger diameter.

17. The irrigation system of claim 1 which in each of the loops, there is a thermostatic system based on increasing the length of a copper wire with a polymer coating which is kept in a protective pod, which makes it possible to increase the length of the wire in its pod in a way that due to its long length, very small changes in temperature can increase its length by a few millimeters.

18. The irrigation system of claim 1 in which at the beginning of the thermostatic sensor pod is designed in such a way that before assembling the water transfer tubes can be entered to the tank from one side and fixed with a plastic bead from inside the tank.

19. The irrigation system of claim 1 in which the outer pod of thermostatic sensor is fixed to the base of the tank and the changes in the length of the wire comparing with its pod can cause increasing the length of protruding part of thermostatic sensor in the other part of the pod.

20. The irrigation system of claim 1 in which existence of an adjustment screw which has the same head as the wire and can rotate with Allen Key make it possible at the beginning of the thermostatic wire pod that by opening and closing the screw, control the placement of the other end of the wire.

21. The irrigation system of claim 1 in which at the end of the wire there is a connection system which is installed to the lower hole of the tank in such a way that if the length increase due to the heat, the wire apply pressure to a valve and by opening and closing the valve allow the water to flow from inside the tank in to the tube.

22. The irrigation system of claim 1 which the alloy used in thermostatic wire can be made of other corrosion-resistant and elastic metals.

23. The irrigation system of claim 1 in which in order to make the tank water flow in each of the loops, other types of thermal sensors, electric valves equipped with electric sensors or other equipment for switching the flow on and off based on measuring the temperature can be used, and the present invention is not limited to the aforementioned thermostatic sensor.

24. The irrigation system of claim 1 which is installed next to the plant under the ground.

25. The irrigation system of claim 1 in which the tubes which inside them keep the thermostatic wires, after going down and reaching the correct level of the root, are transferred to the horizontal plate by going through a 90 degree bend and go through the desired loop on the horizontal plate, then it is connected again with a mild slope to the other connection of the bottom of the tank.

26. The irrigation system of claim 1 in which first by evaluating the amount of temperature and soil moisture and using the data about the optimal humidity and temperature of the soil at the depth of the installation of the tubes, by adjusting the set-up screw can adjust and control the water flow in the tubes.

27. The irrigation system of claim 1 which in case of increasing the temperature due to losing the humidity of the soil, the length of the thermostatic wire increased and by changing the location of the valve in millimeters, the water inside the tank flows in to the tubes.

28. The irrigation system of claim 1 which by existence of thousands holes on the tubes, the water is transferred to the soil around the root under the gravity pressure and cause to increase the level of humidity of the soil.

29. The irrigation system of claim 1 which by increasing the humidity, the temperature of the soil decrease and by decreasing the temperature of the soil, the length of thermostatic wire decreased and the water flow into the tubes is interrupted.

30. The irrigation system of claim 1 which each of water transferring tubes can be installed in a separate plate from the other tube plate.

31. The irrigation system of claim 1 in which each of tubes can be placed in a plate transverse to the other tube plate.

32. The irrigation system of claim 1 which if needed the number of outlet of the tank can be increased in pairs and accordingly the third tubes or more are designed and installed.

33. The irrigation system of claim 1 in which existence of numerous tubes guarantees the operation of the device and the non-drying of the soil in case of problem in any of the other tubes.

34. The irrigation system of claim 1 in which depending on the type of plant and the aggressive behavior of the roots, it is possible to cover around the water transfer tubes using sand piles.

35. The irrigation system of claim 1 in which the sand pile used to cover the tubes can have different sizes in granulation.

36. The irrigation system of claim 1 which the existence of this pile causes the water to enter the sand pile after leaving the transfer tubes and then the aforementioned moisture is transferred from the sandy part to the soil around the roots.

37. The irrigation system of claim 1 in which the amount of root invasion to the openings of the tubes is minimized due to the monotonous distribution of the moisture.

38. The irrigation system of claim 1 in which due to the extent of the wet area in this device, the tendency of the plant root to attack and immigrate to the openings of the transmission tube is minimized.

39. The irrigation system of claim 1 in which a moisture meter sensor in the area of operation of the tubes can send the detection of emptiness of the tank of the system to the central control room in case of reduction of the humidity of the soil and falling the humidity from the set upped standard.

40. The irrigation system of claim 1 in which existence of a pressure switch or a valve equipped with mechanical pressure control installed on the bypass of the pump can correct the delay of the command to stop the flow or prevent the transfer pump from going under pressure by creating a bypass.

41. The irrigation system of claim 1 in which if needed the tank of system can be equipped by a level gage to detect whether it is full or empty.

42. The irrigation system of claim 1 which at time of using the present device in large numbers and regularly and with pre-defined arrangement, it is possible to act in such a way that the outer loop of the device can also provide minimum humidity to the side plant while providing humidification to the related plant.

43. The irrigation system of claim 1 in which in case of damage in one of humidification equipments, the side devices can prevent the plant from drying out.

44. The irrigation system of claim 1 in which it is possible to create an irrigation network consisting of a large number of the same devices for watering plants, and it is possible to create a water transfer system in the form of a network.

45. The irrigation system of claim 1 in which in the main water storage tank of the network by using appropriate fishes and breeding such fishes at the same time with placing ducks as mud-eating birds, it is possible to maximize the amount of nitrates and nutrients in water through the feces of fishes and ducks.

46. The irrigation system of claim 1 in which if fertilization is needed, it is possible to use water-soluble fertilizers at the beginning of the transmission network.
